(19) United States
(12) Patent Application Publication
(10) Pub. No.: US 2004/0015776 A1
(43) Pub. Date: Jan. 22, 2004

(54) Audio visual greeting card

(76) Inventor: Milton Jeffery Scott, Grand Rapids, MI (US)

Correspondence Address: Milton Scott, 9327 2ND Avenue, Inglewood, CA, 90305, US

(21) Appl. No.: 10/199,902

(22) Filed: Jul. 20, 2002

(51) Int. Cl. G06F 17/60

(52) U.S. Cl. 715/500

(57) ABSTRACT

The process of creating a video card incorporating the properties of animation, images (moving or still), textual messages, audio, music score and environmental sounds for production and distribution on storage media capable of reproduction on any video capable display device.

### FEDERALLY SPONSORED RESEARCH

Not Applicable

### SEQUENCE LISTING OR PROGRAM

Not Applicable

### BACKGROUND

1. Field of Invention

This invention generally relates to greeting cards and more particularly to methods for creating multimedia greeting cards for distribution on video storage media for display through devices capable of video playback.

2. Description of Prior Art

The greeting card is the most widely accepted form for communicating sentiment, good tidings or to commemorate a special occasion or event. The traditional greeting card has a print on the card exterior and a text message on the card interior. Most traditional greeting cards are at stores having card display fixtures. The consumer selects from the available card stock the type of cards for the occasion along with an envelope to mail the card. The of choice greeting cards is limited by the style, occasion, print, message and quantity available. Because the traditional greeting card is mass produced, it is possible for someone lo receive identical cards. The traditional greeting card is generally personalized by adding text inside the card or by including pictures with the card when mailed.

Specialized software is available to create a personalized greeting card. The user selects a print from a template or digitizes a picture to insert on the card cover. There is also a feature for adding a pre printed or personal text message inside the card. This feature makes card creation more convenient. However, it still creates a regular greeting card.

The first enhancement to the greeting card was a novelty card with an audio chip. This card plays a pre programmed song when opened. However, the song is only a single octave and has a high audio pitch. This often makes the card more annoying than pleasurable. A similar novelty card with a recordable audio chip followed. This card allows the user to record the sound to be played when the card is opened. However, this audio chip only allows the user one chance to make a 10 seconds audio recording.

U.S. Pat. Nos. 6,295,058 to Hsu (2001), U.S. Pat. No. 6,369,908 to Frey (2002) and U.S. Pat. No. 6,288,319 to Catona (2001) refer to the creation and distribution of electronic greeting cards that are delivered as electronic mail or are recorded on video storage media. Each of these patents allow a user to add multimedia in the form of animation, images, text, music and audio to a greeting card created using each respective method. The electronic greeting card method provides the user with a limited number of animation or sound files to utilize during the creation process. Images and audio can be recorded and imported into the card also. However, the Internet bandwidth limits the amount of information that can be added to the card. This limits the amount of customization a user can use in the creation of a card. In addition, the electronic card is limited to both creation and viewing on an Internet capable device.

A review of prior art and other methods available illustrate no procedure or process for creating greeting cards that are designed specifically for

(a) playback as a video;

(b) using stories to commemorate an occasion or event;

(c) using music scores; and

(d) using characters interacting as part of the card.

### OBJECTS AND ADVANTAGES

Accordingly, several objects and advantages of the present invention are:

(a) providing a greeting card that can be personalized using multimedia;

(b) providing a means to record an audio soundtrack;

(c) providing a means for the user to specify the score genre;

(d) providing a means to display hi quality images and animation;

(e) providing a greeting card that is displayed on a television or video monitor;

(f) providing a greeting card that is completely configurable;

(g) providing a greeting card that a short movie;

(h) providing a greeting card with animated characters interacting;

(i) providing a greeting card with moving characters and objects; and

(j) providing a greeting card that is entertaining.

### SUMMARY

In accordance with the present invention the creation process and production of an audio visual greeting card comprising multimedia and is playable on a video displaying device.

### DRAWINGS

### Drawing Figures

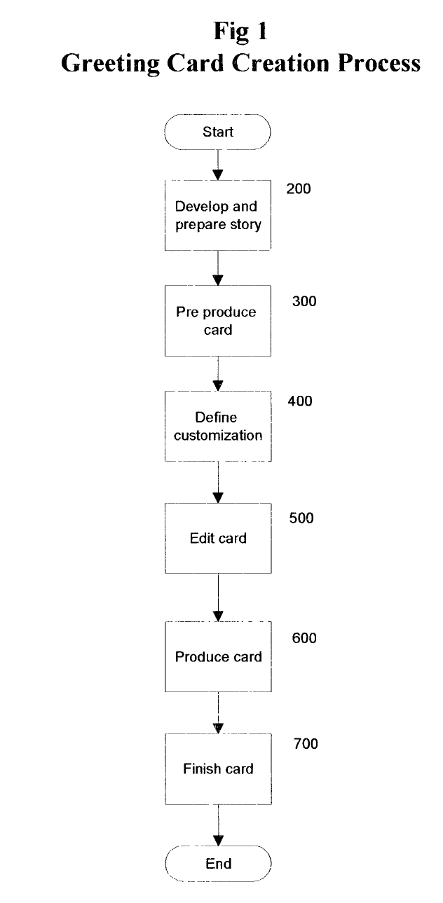

FIG. 1 is a block diagram of the entire process for creating an audio visual greeting card.

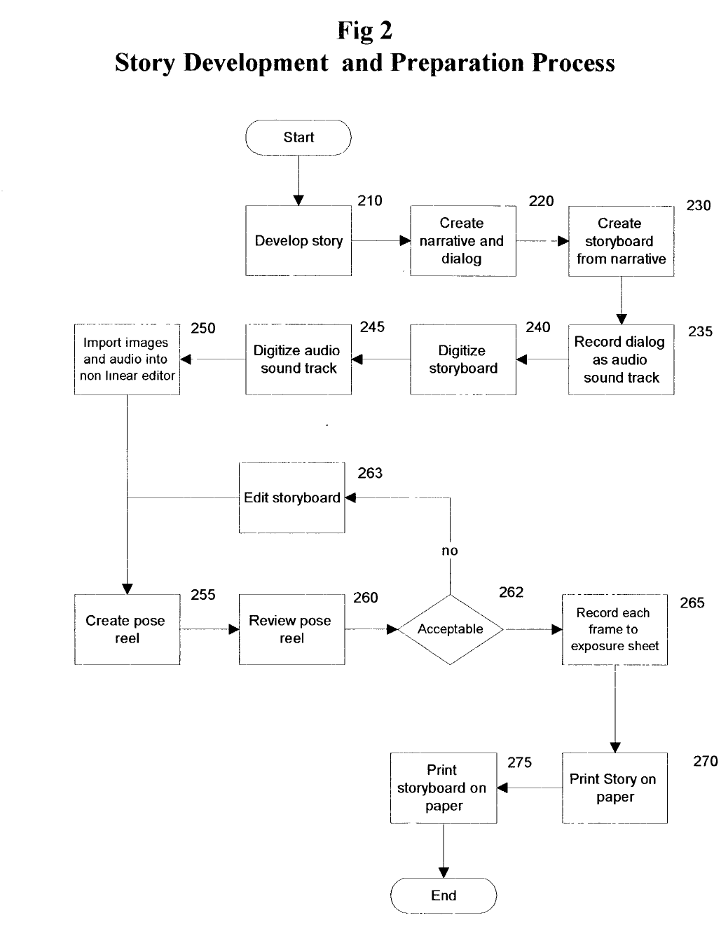

FIG. 2 is the development process.

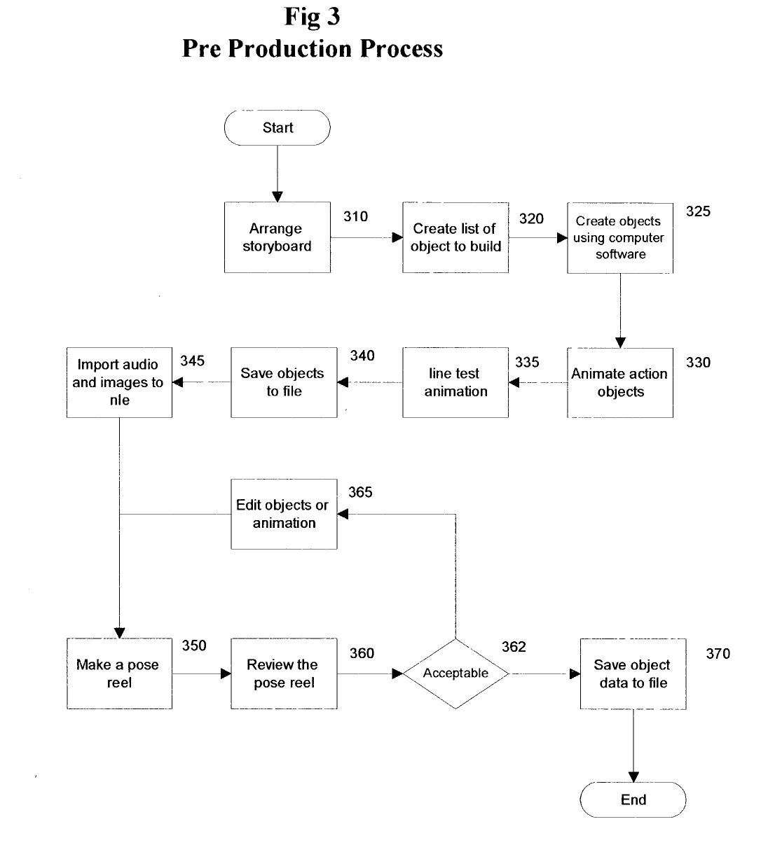

FIG. 3 is the pre production process.

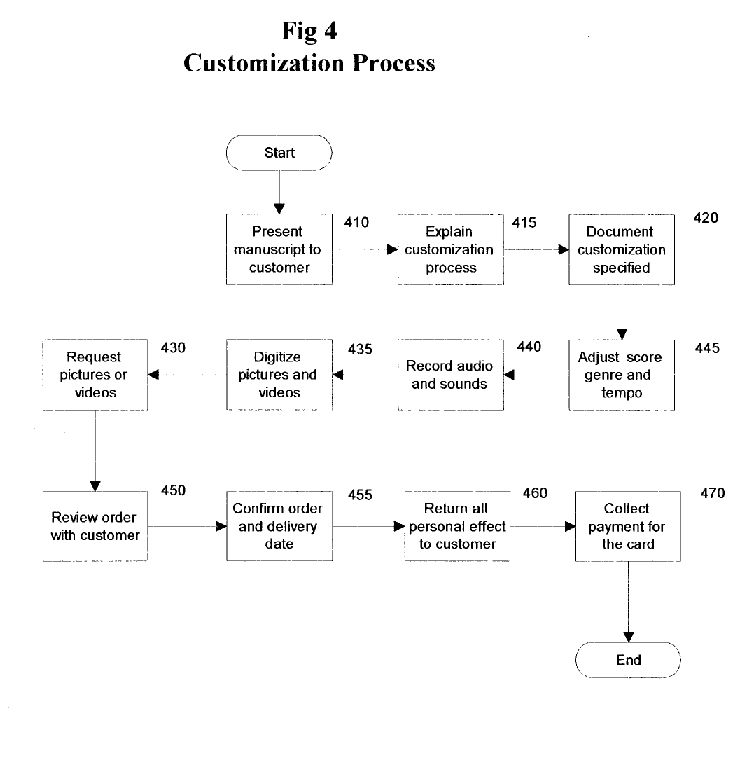

FIG. 4 is the customization process.

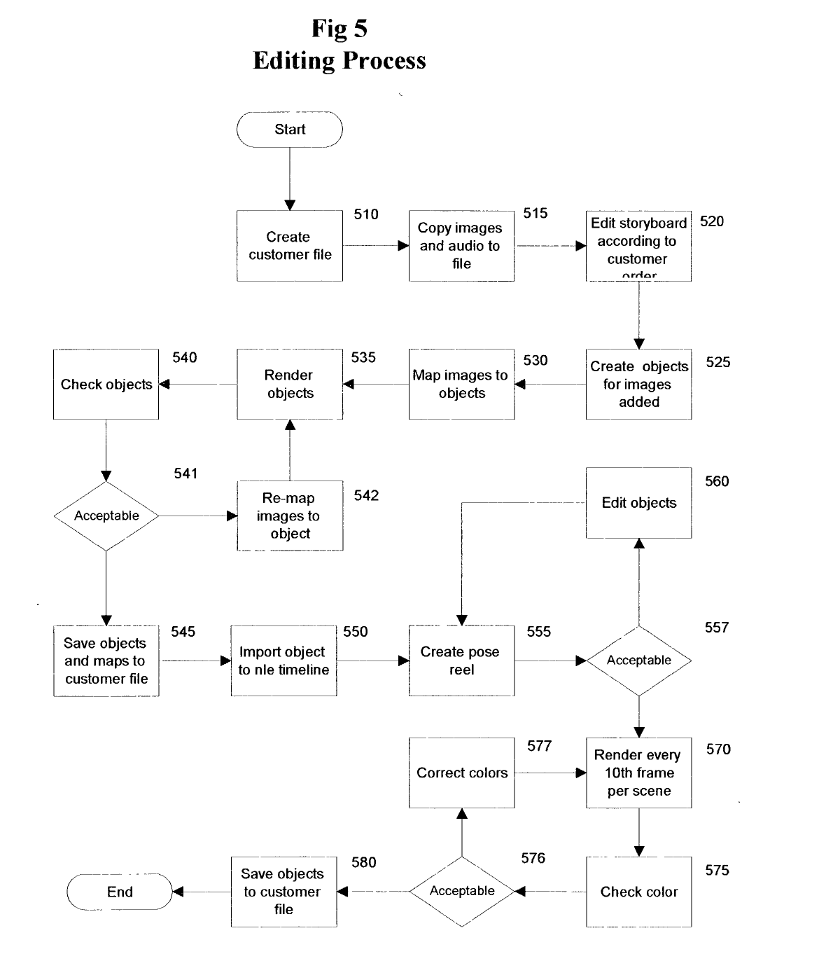

FIG. 5 is production editing process.

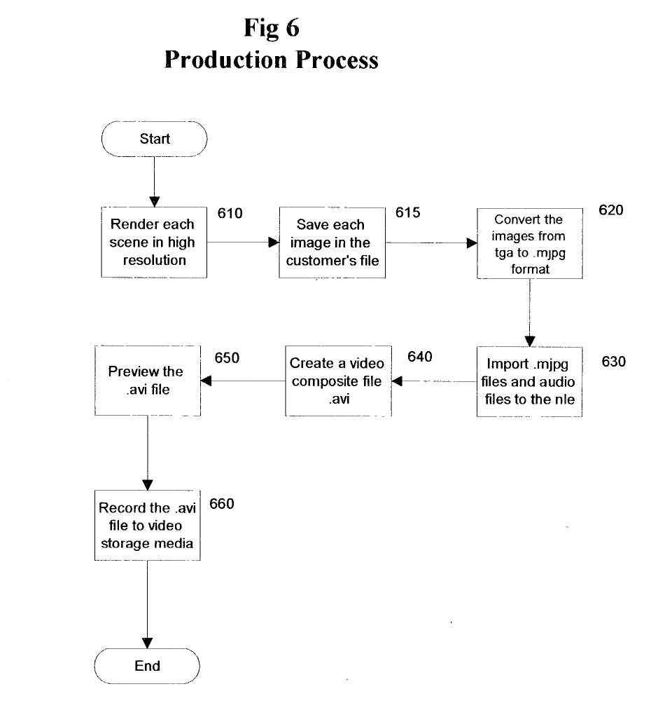

FIG. 6 is the production process.

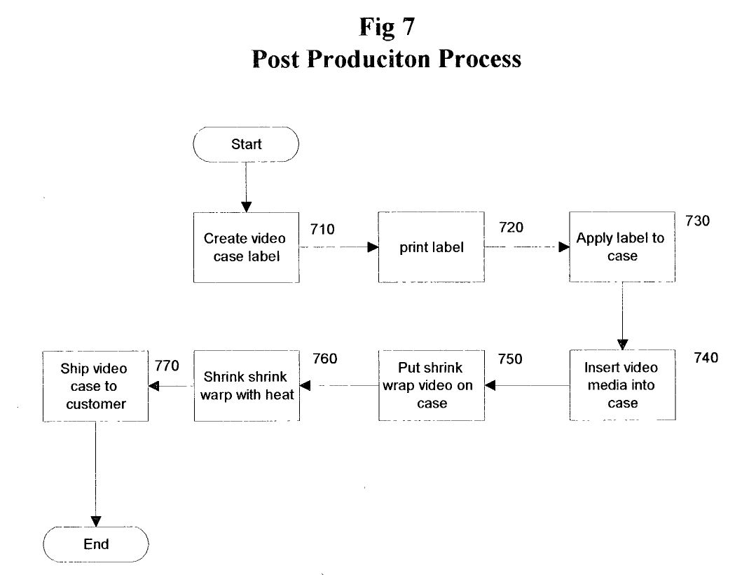

FIG. 7 is the post production process.

### DETAILED DESCRIPTION

### Description—FIGS. 1-7

A preferred embodiment of the process for the present invention is illustrated in FIG. 1. The process begins by developing or acquiring a manuscript for an occasion or event (210). Develop the narrative and dialog for a script from said manuscript (220). Convert the narrative into images for a storyboard (230). Read and record the dialog to create an audio sound track (235). Digitize the storyboard images and save as a computer image file (240). Digitize the audio sound track and save as a wave file (245). Import the image and wave files into a non linear editing (nle) program, a sequencer which produces a composite video file using a timeline and separate tracks for independent audio and video files (250). The program compiles the images and audio to create a pose reel (255). Review the pose reel for irregularities in story continuity (260). Record each frame of the pose reel to an exposure sheet if acceptable. Annotate the animating directions and lip synchronization on the exposure sheet (265). Edit the storyboard if not accepted (263). Print the storyboard on a 24 pound paper stock (270) and print the manuscript on a 20 pound paper stock (275) for presentation to the customer.

FIG. 3 describes the pre-production process. Arrange the storyboard images in the same sequence as the pose reel (310). Create a list of the animate and inanimate objects required for the greeting card (320). Create the objects using an object modeling software application (325). Add animation information to the animated objects (330). Create a line test for the objects using a quick rendering method (335). Save all the object information as an object file (340). Import the object files and the audio files to the (nle) timeline arranging them according to their sequence on the storyboard (345). Compile the objects and audio tracks into a pose reel (350). Review the pose reel (360). If unacceptable, edit the object or animation information and reprocess (365). If acceptable, save all data to a project file (370).

FIG. 4 describes the customization process. Present the manuscript and storyboard for the occasion to the customer (410). Describe the story flow and explain customization process (415) Document the customer's enhancements on an order form (420). Request pictures and videos from the customer (430). Convert said items into digital images and file (435). Record and digitize audio or sounds the customer wants to add (440). Document changes to the genre and tempo of the score on the order form by scene (445). Review the order with the customer and select the media for playback (450). Confirm the order and the delivery date with the customer and acquire a signature for verification (455). Return all customer's personal effects and provide a copy of the order form (460). Collect payment for the card from the customer (470).

FIG. 5 describes the editing process. Create a computer file for the customer (510). Place a copy of the original storyboard in the file along with any image and sound files (515). Open the storyboard file and edit it according to the customer's specifications on the order form (520). Create an object for all images and video files added to the card (525). Map the digital images to the objects (530). Render the objects (535) and check for accurate placement (540). If unacceptable, re-map the images and repeat the process (542). If acceptable, save objects and maps as object files (545). Import all the object files and audio files into the (nle) timeline arranging them according to their sequence on the storyboard (550). Compile the objects and audio tracks into a pose reel (555). If unacceptable, edit the object and repeat the process (560). If acceptable, render every tenth frame in each scene in high resolution (570). Check the image color attributes (575). If unacceptable, correct the color attributes and reprocess (577). If acceptable, save the object in the customer's files (580).

FIG. 6 describes the production process. Render each scene in high resolution (610) and save in the customer's file (615). Convert the rendered images from a tga file format to a mjpg file format (620). Import the mjpg files and audio files to the (nle) timeline arranging them according to their sequence on the storyboard (630). Compile the audio and video tracks into an avi, a composite video file format (640). Preview the avi file for quality (650). If unacceptable correct and re-render (655). If acceptable, record the avi file from the (nle) to the video playback media on the order form (660).

FIG. 7 describes the post production process. Create a label for the video case according the to customer's specification (710). Print the label (720) and apply it to the case (730). Insert the video playback media into the case (740). Wrap the case with a shrink wrap film (750). Heat the shrink warp until it conforms to the shape of the video case (760). Ship the video case to the customer (770).

### Conclusion, Ramification, and Scope

Accordingly, the reader will see that the audio video card is a multimedia presentation customized by the customer. The audio visual card does not require the sender to possess any special equipment. The receiver only needs a device capable of playing the video media. Additionally, the audio visual card is specifically for video playback. The occasion or commemorated event is the story, interacting characters, dialog, music, and text. Furthermore, the audio visual card has other advantages in that

it can be reused or added to,

it can be designed as a gift,

it is memorabilia,

it has a serviceable life equal to the life of the video media,

it is easy to use,

it can be used in marketing, and

it is adaptable for use with new video technology.

Accordingly, the scope of the invention should be determined not by the embodiment(s) illustrated, but by the appended claims and their legal equivalents.

I claim:

1. A method for creating a greeting card comprising a manuscript of an occasion or event and multimedia.

2. The manuscript of claim 1 wherein is a script.

3. The manuscript of claim 1 wherein is a screenplay

4. The manuscript of claim 1 wherein is a poem.

5. The manuscript of claim 1 wherein is a short story.

6. The manuscript of claim 1 wherein is an essay.

7. The multimedia of claim 1 wherein is an animate or inanimate 2D or a 3D object.

8. The interaction of claim 7 wherein an object is a hand drawn and digitized.

9. The interaction of claim 7 wherein an object is computer generated.

10. The interaction of claim 7 wherein a character interacts with another character.

11. The interaction of claim 7 wherein a character interacts with an object.

12. The multimedia of claim 1 wherein is an audio sound track

13. The multimedia of claim 1 wherein is a musical score.

14. The multimedia of claim 1 wherein is a text message

15. The text message of claim 14 wherein is a text image mapped on a 2D or a 3D object

16. A greeting card video comprising a story, an interaction between an animate or inanimate object, an audio sound track, a musical score, and a text message.

17. The video in claim 16 wherein is recorded on a video storage media.

18. The video in claim 16 wherein is played through a video displaying device.

19. The video in claim 16 wherein is displayed through a monitor.
